(19) United States
(12) Patent Application Publication
(10) Pub. No.: US 2017/0316052 A1
(43) Pub. Date: Nov. 2, 2017

(54) ANALYTICS INTERFACE FOR A TRANSACTIONAL DATA STORE

(71) Applicant: Microsoft Technology Licensing, LLC, Redmond, WA (US)

(72) Inventors: Adrian Marius Marin, Bellevue, WA (US); Josh Honeyman, Redmond, WA (US); Sridhar Srinivasan, Sammamish, WA (US)

(21) Appl. No.: 15/339,791

(22) Filed: Oct. 31, 2016

Related U.S. Application Data
(60) Provisional application No. 62/330,181, filed on May 1, 2016.

(51) Int. Cl. G06F 17/30

(52) U.S. Cl. CPC G06F 17/30404; G06F 17/30339

(57) ABSTRACT

An analytics system for providing an interface for supporting analytics processing of data of a data store is provided. The system receives an analytics data model and a mapping of a data model to the analytics data model. The system initializes a data store that supports the analytics data model by extracting data from the data store and storing the extracted data in the analytics data store based on the mapping. Upon receiving a notification of a change to data of the data store, the system updates the data of the analytics data store as indicated by the mapping. The system receives, via an analytics interface, a query based on the analytics data model and converts the query into a store query. The system submits the store query to the analytics query engine to generate a query result and provides the query result as the result of the query.

### CROSS-REFERENCE TO RELATED APPLICATION

This application claims the benefit of U.S. Provisional Application No. 62/330,181, filed May 1, 2016, which is hereby incorporated by reference in its entirety. In cases in which a document incorporated by reference herein is inconsistent with contents of this application, the contents of this application control.

### BACKGROUND

Transactional processing systems store vast amounts of data based on a transactional data model that allows for short response times (e.g., sub-second response times) for transactions that include adding, updating, and deleting of data stored in transactional data stores. Such a transactional data model employs a highly normalized form to minimize data redundancy so that, for example, a transaction to change an attribute for an entity (e.g., the address of a customer) needs to access only a single record in the transactional data store. Although such transactional data models are very effective at supporting transactional processing, they can be quite inefficient at supporting analytics processing. Analytics processing typically requires sophisticated data aggregations such as various aggregations for total sales by store, city, and state for each day, week, month, quarter, and year. Because a transactional data model employs a highly normalized form, analytics processing would need to generate the aggregations from the raw data every time the aggregations are needed. Since a transactional data store can include millions and even billions of records, the generating of such aggregations can be time-consuming and require vast amounts of computational resources. Moreover, if analytics processing and transactional processing are performed concurrently against the same transactional data store, the response time for the transactional processing may be unacceptably long.

Organizations typically perform analytics processing for all of their transactional processing systems, such as Enterprise Resource Planning (“ERP”) systems and Customer Relationship Management (“CRM”) systems, to gain insight and intelligence into the operations of their organization. These transactional processing systems may employ very different transactional data models and store data in transactional data stores that have different storage infrastructures and different volume sizes. Such organizations typically would like to perform analytics processing to support report generation and on-demand queries with low data latency (data freshness), sub-second response times, and consistent results. The organizations would also like such analytics processing to have a minimal impact on the load of the transactional processing systems.

Available technologies meet some of the needs of these organizations. For example, these technologies may use parallel computing to process large volumes of data, provide in-memory storage for rapid access to data, and provide optimized data compression to reduce the amount of storage that is needed to store the data. These technologies, however, do not support all the needs of these organizations. For example, to support an acceptable query response time (e.g., in real time) for analytics processing, the technologies may require modification to the transactional data model. Such modifications to a transactional data model require modifying the transactional processing system itself, which can be expensive and error-prone. In addition, the modifications to the transactional data model would likely have a negative impact on the response time for transactional processing or require additional hardware infrastructure, which can be very expensive to purchase and maintain.

### SUMMARY

An analytics system for providing an interface for supporting analytics processing of data of a data source store (e.g., a transactional data store) is provided. The system receives an analytics data model and a mapping of a data source model of the data source store to the analytics data model. The system initializes an analytics data store that supports the analytics data model by extracting data from the data source store and storing the extracted data in the analytics data store as indicated by the mapping. The system registers to receive notifications of changes to data of the data source store. Upon receiving a notification of a change to data of the data source store, the system updates the data of the analytics data store as indicated by the mapping. The system receives via an analytics interface an analytics query in an analytics query language based on the analytics data model. The system can support multiple analytics query languages. The system converts the analytics query into an analytics store query in an analytics store query language that is based on an analytics store data model. The system can support multiple analytics store platforms and multiple analytic store query languages. The system submits the analytics store query to an analytics store query engine to generate a query result and provides the query result as the result of the analytics query.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

### BRIEF DESCRIPTION OF DRAWINGS

FIG. 1 is a flow diagram that illustrates overall processing of the analytics system in some embodiments.

FIG. 2A is a block diagram that illustrates the overall architecture of the analytics system in some embodiments.

FIG. 2B is a block diagram that illustrates the data models of the analytics system in some embodiments.

FIG. 3 is a flow diagram that illustrates processing of a generate mapping component of the analytics system in some embodiments.

FIG. 4 is a flow diagram that illustrates processing of an initialize analytics data store component of the analytics system in some embodiments.

FIG. 5 is a flow diagram that illustrates processing of a subscribe component of the analytics system in some embodiments.

FIG. 6 is a flow diagram that illustrates processing of a receive change event component of the analytics system in some embodiments.

### DETAILED DESCRIPTION

A method and system are provided that support analytics processing of data of a data source system in real time with minimal impact on the response time of the data source system. In some embodiments, an analytics system includes an analytics data model repository, an analytics data store, an extraction service, and an analytics interface. The analytics data model repository stores an analytics data model and a mapping from a data source model of the data source store to the analytics data model. The analytics data model may employ a star schema (with fact tables and dimension tables), and the data source model may represent a relational database (with tables and views). The mapping specifies the data of the data source model that corresponds to data of the analytics data model. For example, the mapping may map a certain attribute of a certain table in the data source model to a certain measure of a certain fact table of the analytics data model. The mapping may also specify how to convert data of the data source model to be compatible with the data of the analytics data model. For example, a conversion may be to change a character representation of a number into an integer representation of the number. The measures of the fact tables are generally aggregations of data of the data source store. When the analytics system supports analytics for multiple data source systems, the analytics data model repository stores an analytics data model and mapping for each transactional data store.

In some embodiments, the extraction service may employ a push model, a pull model, or a combination of a push model and a pull model. With a push model, the extraction service registers to receive notifications of changes to the data of the transactional data store. The notifications include data extracted from the transactional data store by the transactional data system. With the pull model, the extraction service also registers to receive notifications of changes to the data of the transaction data store, but the extraction service is responsible for extracting the data. The extraction service extracts data from a data source store, that is a transactional data store, for populating an analytics data store based on the analytics data model and the associated mappings to the transactional data store. To extract the data, the extraction service runs queries against tables and/or views of the transactional data store or a copy of the transactional data store that may be maintained as a backup and is read-only. The extraction service stores the extracted data in the analytics data store to support the analytics data model. The extraction service may generate various aggregations to support the analytics data model. The data in the analytics data store may be materialized, stored in memory, and stored in a columnar form to support a fast response time for the analytics processing. As transactions are performed against the transactional data store, the extraction service extracts or receives extracted information describing the modifications and updates the analytics data store. In some embodiments, if the extraction service does not receive notifications from the transactional data store, the extraction service may periodically access change information of the transactional data store and extract information based on those changes. The extraction service may use a relatively short period to ensure the freshness of the data of the analytics data store.

In some embodiments, an analytics interface supports the performing of analytics data in the analytics data store. The analytics interface employs the analytics data model for the data of the analytics data store. The analytics interface provides interfaces for application programs and, optionally, a user interface. The analytics interface may provide an application programming interface to various application programs such as a spreadsheet program, a business analytics interface, a database system, a data mining application, a machine learning application, and so on. The analytics interface provides components for converting an analytic query in the analytics query language, such as Multidimensional Expressions (“MDX”), of an application program to an analytics store query in an analytics store query language U-Structured Query Language (“U-SQL”)“ ”. The components submit the analytics store queries to an analytics store query engine, receive the query result from the analytics store query engine, and provide the query result to the application programs. The analytics store query engine generates and executes a query plan to extract the query result of the query.

The analytics system provides for analytics processing of data by storing the data in a form that is optimized for analytics processing and by maintaining the freshness of the data. Moreover, by storing the data in an analytics data store that is separate from the transactional processing data store, the analytics processing will have minimal or no impact on the response time of the transactional processing system.

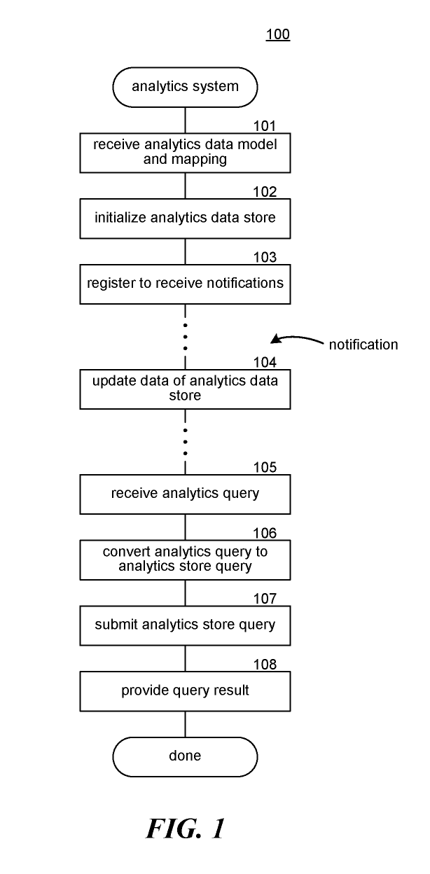

FIG. 1 is a flow diagram that illustrates overall processing of the analytics system in some embodiments. The analytics system 100 initializes the analytics data store, updates the analytics data store based on changes to the data of transactional data stores, and provides an analytics interface for retrieving data from the analytics data store. In block 101, the analytics system receives the analytics data model along with a mapping from transactional data models to the analytics data model. In block 102, the analytics system initializes the analytics data store by creating a schema (e.g., table, view, and indexes) for the analytics data store and populating the analytics data store based on the mapping and data extracted from the transactional data stores. In block 103, the analytics system registers to receive notifications of changes to the data of the transactional data stores that is mapped to the analytics data model. In block 104, the analytics system, upon receiving a notification of a change to the data of a transactional data store, updates the data of the analytics data store. In block 105, the analytics system receives an analytics query in an analytics query language from an application program. In block 106, the analytics system converts the analytics query to an analytics store query in an analytics store query language. In block 107, the analytics system submits the analytics store query to the analytics store query engine. In block 108, after receiving the query result, the analytics system provides the query result to the application program as the result of the analytics query.

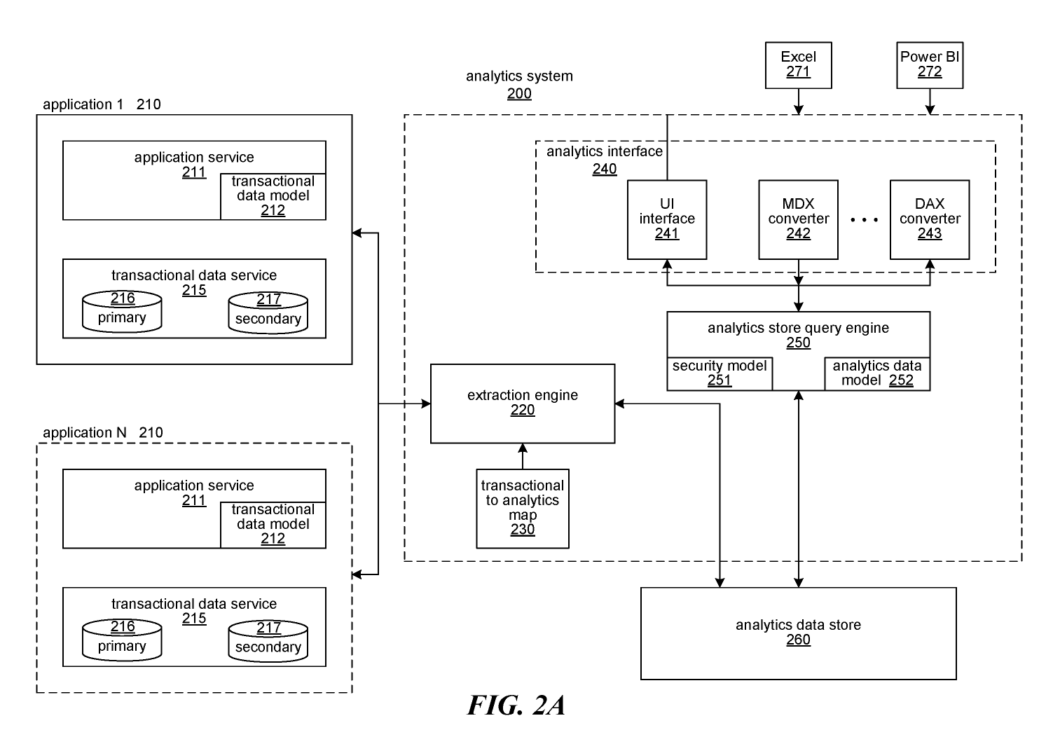

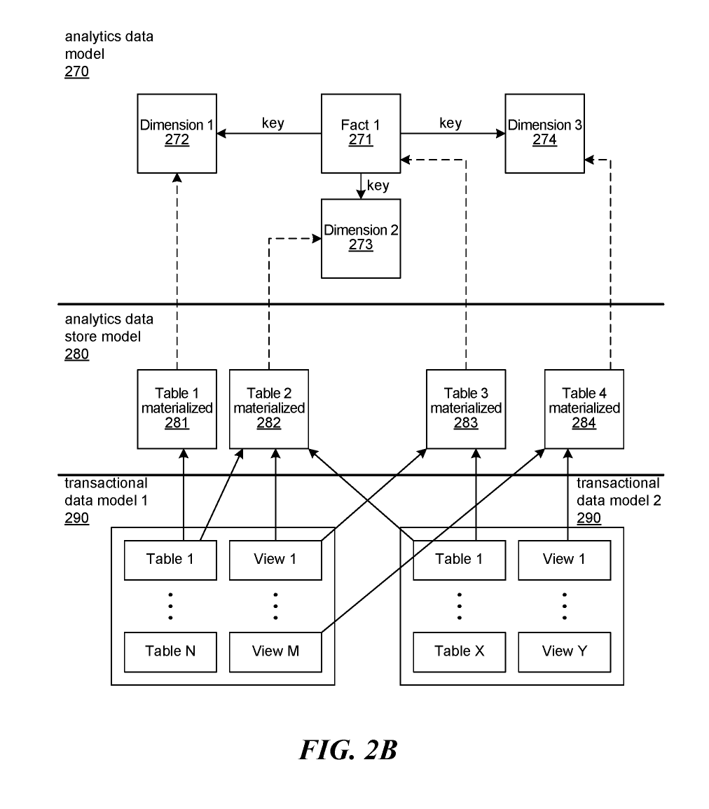

FIG. 2A is a block diagram that illustrates the overall architecture of the analytics system in some embodiments. The analytics system 200 includes an extraction engine 220, a transactional to analytics map 230, an analytics interface 240, and an analytics store query engine 250. The analytics system interfaces with various applications such as Excel 271 and Power BI 272 and an analytics data store 260. The extraction engine interfaces with application programs 210 that each include an application service 211 and a transactional data service 215. An application service provides application processing, and the data service stores the data of the application. The applications may be transactional processing systems. The data service may store the data in a primary database 216 and store a replica of the primary database in a secondary database 217. The primary database supports the transactions of the transactional processing system, and the secondary database is a database that may serve as a backup (e.g., at a remote location) or may be specially created to support the data extraction of the analytics system. The secondary database may be updated in real time or near real time to ensure the freshness of its data. Each application service may access a transactional data model 212 for its transactional data store. The transactional data services may employ heterogeneous transactional data models and heterogeneous database systems (e.g., a relational database management system, a Resource Description Framework database system, and a hierarchical database system).

The extraction engine extracts data from the data services that is defined by the mapping from the transactional data models to the analytics data model and stores the extracted data in the analytics data store in a materialized form that is optimized to support analytics processing. After initially populating the analytics data store, the extraction engine monitors changes to the databases of the data services and updates the analytics data store to reflect those changes. The extraction engine may include a notification service and an extraction service. The notification service registers to receive notifications of change to the data of a transactional data store, for example, using a subscription/publication model. When the extraction engine receives a notification of a change, the extraction service either receives the changed data extracted by the transactional data service or extracts the changed data from the transactional data store. In some embodiments, the analytics system may be provided as a cloud service to customers. For each customer, the analytics system maintains a separate analytics data store, analytics data model, and mapping from various transactional data models of the customer to the analytics data model for the customer. A customer may have various transactional and non-transactional data stores, such as a customer relationship management (“CRM”) system, a human resources system, a point-of-sale system, and so on, whose data models are mapped to the analytics data store.

The analytics interface provides a UI interface 241 and various converters, such as an MDX converter 242 and a Data Analysis eXpressions (“DAX”) converter 243, to convert analytics queries to analytics store queries. The UI interface is an optional interface and provides a user interface for analytics processing such as defining queries to be submitted to the analytics store query engine to retrieve the query result from the analytics data store. The analytics store query engine accesses a security model 251 and an analytics data model 252. The security model may derived from the security models of the application programs to ensure that access to the analytics data store is consistent with those security models. Changes to the security models of the application programs can be sent automatically to and be used as the security model of the analytics system. The analytics system may also allow the security model of the analytics system to be modified so that it deviates from the security models of the application programs. Alternatively, the security model of the analytics system may be established independently of the security models of the application program. In such a case, the analytics system may provide a component for establishing the security model of the analytics system. The analytics store query engine receives analytics store queries, generates query plans, and executes the query plans against the data of the analytics data store to generate the query results for the analytics queries.

FIG. 2B is a block diagram that illustrates the data models of the analytics system in some embodiments. The data models include an analytics data model 270, an analytics data store model 280, and transactional data models 290. The analytics data model is represented using a star schema. Each fact table is linked to various dimension tables. Fact table 271 is linked to dimension tables 272-274. As an example, a simple fact table may contain the number of units sold and the sales amount aggregated by date, store, and product. The dimension tables contain the attributes of the facts. For example, a date dimension table may contain a row for each date that contains a unique key for the date, day of the week, month, and year, and a store table may contain a row for each store that contains a unique key, store number, city, and state. Each row of the fact table contains the number of units sold and an external key to a row in each of the three dimension tables. The transactional data models include tables and views defined by the underlying data stores. The transactional data models 290 includes tables and views. The analytics data store model 280 represents table, such as materialized tables 281-284. The analytics data store model may also represent views (e.g., to handle many-to-many relations on to support various dimensions). The arrows between the data sources and the analytics data store illustrate that data from the various tables and views are stored in various tables of the analytics data store.

When an analytics data model is defined, the field of each fact table is mapped to the field of the table or view of the transactional data model that corresponds to that fact. Similarly, each field of a dimension table is mapped to the field of a table or view of the transactional data model that corresponds to that attribute. A fact table of the analytics data model contains an aggregation to support analytics processing. For example, a fact table may contain the number of units sold aggregated by day, month, and year, and another fact table may contain the number of units sold aggregated by store and city.

The extraction engine inputs the mapping from fields of tables or views of the transactional data model to the analytics data model, extracts the data from the transactional data store based on the mapping, and stores the extracted data in the analytics data store as materialized tables. In some embodiments, the materialized tables are stored in memory and in columnar form. The extraction service may be centralized or may be distributed across different transactional processing systems and other data providers that implement transformation logic to bring the data from the source into the structured format and storage of the analytics data store. A centralized extraction service retrieves the data from the sources by using a contract that defines the data models of the sources and the mapping between those data models and the analytics data model. Such an extraction service may be responsible for a full extract-transform-load (“ETL”) process. The extraction service may also manage provisioning of the analytics data store and any underlying data pipeline services.

The analytics system hosts the analytics data models that provide a unified schema for reporting and (on-demand) data analysis. The analytics system provides a common interface to the data in the analytics data store for all the applications that consume and process analytics data. The analytics system also provides the functions for data mash-up and data reconciliation through mechanisms to select objects from the analytics data store that will be used to source the data for each query sent by analytics applications to the analytics interface. For example, data mash-up and data reconciliation may identify the primary sources of data when multiple data sources store the same data. The analytics system exposes a unified set of data abstractions and relations that can be queried by reports and tools for data analysis, such as a spreadsheet application. The analytics system is also responsible for ensuring secure access to the data and the definition of common security policies such as row-level security across all data in the analytics data store. The analytics system may also support different query languages for analytics reports in order to provide compatibility with existing (legacy) reporting applications. Such applications can connect to the analytics interface and query the analytics data store through the analytics data model by sending queries in one of the languages supported by the analytics interface.

The analytics system may include a data intelligence service, that is, a data processing layer that both sources data from and outputs data to the analytics data store and through the analytics data model. The data intelligence service allows for data processing operations, such as data mining or machine learning, on the data extracted from the transactional data stores.

The extraction service generates the physical data models for the analytics data store. The extraction service creates a mapping from the analytics data model to the objects in the physical data model of the analytics data store. The extractions service may extract data using full or incremental updates from the transactional data stores for insertion into the analytics data store. The extraction service may use Structured Query Language (“SQL”) change tracking to track changes in the transactional data stores. Alternatively, the extraction service may use change data capture when the data changes are recorded in the secondary data store. Change tracking and change data capture are built-in mechanisms in SQL servers to record changes in SQL tables. The most common data sources for facts and dimension objects in the analytics data models are likely to be views that join multiple tables or other views. The “delta” changes for a view V that joins, for example, two tables T1 and T2 may be determined either as

ΔT1 join T2

UNION

T1 join ΔT2

where ΔT1 represents the rows of T1 that have changed and ΔT2 represents the rows of T2 that have changed, or

changetable(changes T1, @Version) join V

UNION

changetable(changes T2, @Version) join V.

In some embodiments, the analytics data store stores data using a materialized flat table. For example, a view for the transactional data store for one of the facts or dimensions in the analytics data model is materialized in the analytics data store into a flat table with only those fields that are referenced by the dimension object in the analytics data model and mapping. For example, a dimension with 10 attributes mapping to 10 different fields of a 100-column view in the transactional data store is mapped in the analytics data store into a table with 10 fields bearing the name of the dimension attributes. Each table in the analytics data store may include a clustered column store index, which enables higher data compression (e.g., 10×), parallel execution plans for the queries, and improved in-memory storage and processing of the queried data. The data in the analytics data store may be Huffman coded to enable improved performance on string operations. The precision and scale settings of the numeric values used in aggregations may be set, for example, to not exceed 18, which may improve the performance of the aggregation operations up to 10 times.

The computing systems on which the analytics system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include servers of a data center, massively parallel systems, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the analytics system. The data transmission media are used for transmitting data via transitory, propagating signals or carrier waves (e.g., electromagnetism) via a wired or wireless connection.

The analytics system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the analytics system may be implemented in hardware using, for example, an application-specific integrated circuit (ASIC).

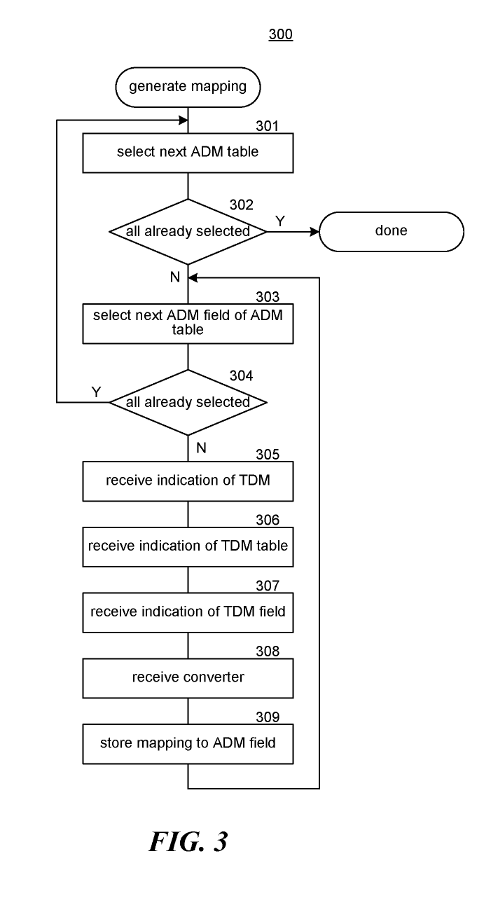

FIG. 3 is a flow diagram that illustrates processing of a generate mapping component of the analytics system in some embodiments. A generate mapping component 300 supports the generating of a mapping from a transactional data model (“TDM”) to an analytics data model (“ADM”). In block 301, the component selects the next table of the analytics data model. In some embodiments, the mapping may be from the transactional data model to a physical data model that is mapped to the analytics data model. In decision block 302, if all the tables of the analytics data model have already been selected, then the component completes, else the component continues at block 303. In block 303, the component selects the next field of the selected table of the analytics data model. In block 304, if all the fields of the selected table of the analytics data model have already been selected, then the component loops to block 301 to select the next table of the analytics data model, else the component continues at block 305. In block 305, the component receives an indication of a transactional data model. In block 306, the component receives an indication of a table of the transactional data model. In block 307, the component receives an indication of a field of the selected table of the transactional data model. In block 308, the component receives an indication of a converter for converting the data of the field. In block 309, the component stores a mapping from the field of the transactional data model to the field of the analytics data model and then loops to block 303 to select the next field of the selected table of the analytics data model. In some embodiments, multiple fields may map to the same field of the analytics data model. In such a case, the converter may process the data in those fields to generate new data for the fields of the analytics data model. For example, the analytics data model may include a field that is an average sale amount for a store for each day. In such a case, the conversion may total the sales amount of each transaction and divide by the number of transactions.

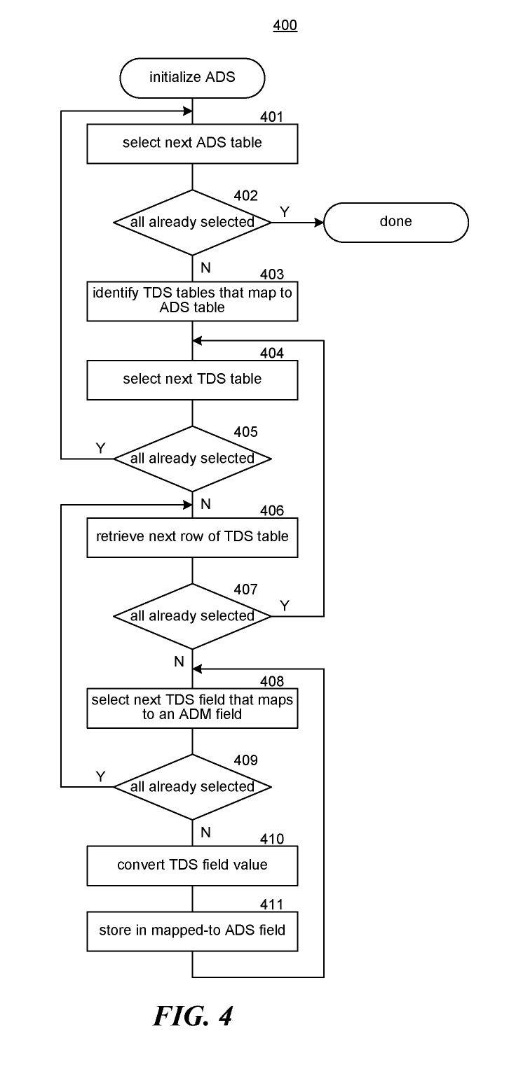

FIG. 4 is a flow diagram that illustrates processing of an initialize analytics data store component of the analytics system in some embodiments. An initialize analytics data store (“ADS”) component 400 is invoked to initially populate an analytics data store. In block 401, the component selects the next table of the analytics data store. In decision block 402, if all the tables have already been selected, then the component completes, else the component continues at block 403. In block 403, the component identifies the tables of the transactional data store that map to the selected table of the analytics data store. In block 404, the component selects the next identified table. In decision block 405, if all the identified tables of the transactional data store have already been selected, then the component loops to block 401 to select the next table of the analytics data store, else the component continues at block 406. In block 406, the component retrieves the next row of the selected table of the transactional data store. In decision block 407, if all the rows have already been selected, then the component loops to block 404 to select the next identified table of the transactional data store, else the component continues at block 408. In block 408, the component selects the next field of the selected row that maps to the field of the analytics data model. In decision block 409, if all such fields have already been selected, then the component loops to block 406 to select the next row of the selected table of the transactional data store, else the component continues at block 410. In block 410, the component converts the value of the selected field of the transactional data store. In block 411, the component stores the value in the mapped-to field of the analytics data store and then loops to block 408 to select the next field of the selected row.

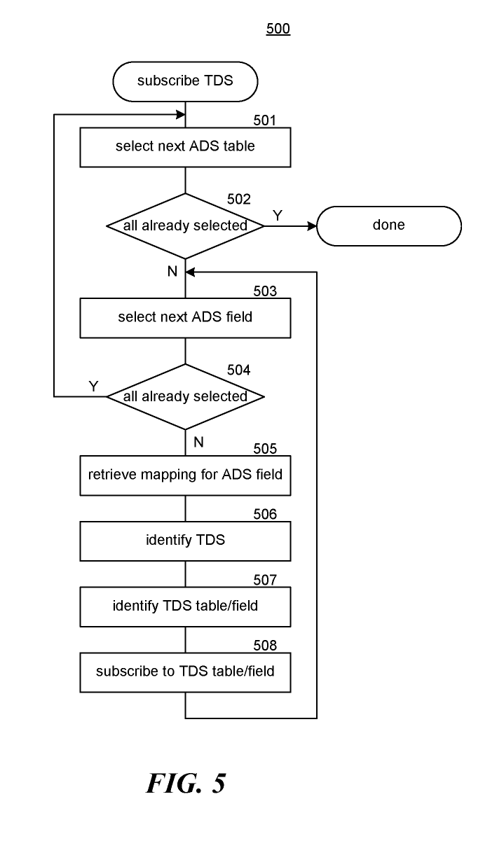

FIG. 5 is a flow diagram that illustrates processing of a subscribe component of the analytics system in some embodiments. A subscribe component 500 subscribes to the various transactional data stores to receive notifications of changes to fields whose values affect the data of the analytics data store. In block 501, the component selects the next table of the analytics data store. In decision block 502, if all such tables have already been selected, then the component completes, else the component continues at block 503. In block 503, the component selects the next field of the selected table of the analytics data store. In decision block 504, if all such fields have already been selected, then the component loops to block 501 to select the next table of the analytics data store, else the component continues at block 505. In block 505, the component retrieves the mapping for the selected field. In block 506, the component identifies the transactional data source for that field. In block 507, the component identifies the table and the field of the transactional data store that is mapped to the selected field of the analytics data store. In block 508, the component subscribes to changes in the selected field of the transactional data store. The component then loops to block 503 to select the next field of the selected table of the analytics data store.

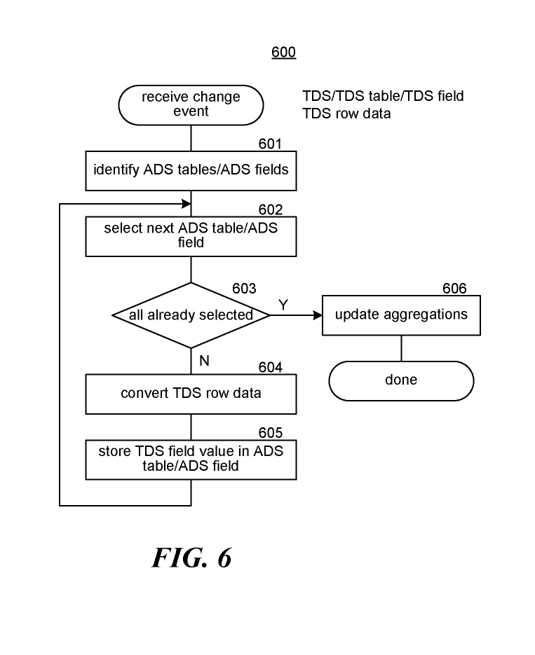

FIG. 6 is a flow diagram that illustrates processing of a receive change event component of the analytics system in some embodiments. A receive change event component 600 receives an indication of a field of a row that has been updated and the data for that row and updates the analytics data store. In block 601, the component identifies the fields within tables of the analytics data store that the data of the row map to. In block 602, the component selects the next identified field of the analytics data store. In decision block 603, if all the identified fields have already been selected, then the component continues at block 606, else the component continues at block 604. In block 604, the component converts the data of the row as specified by the mapping. In block 605, the component stores the converted value in the selected field of the analytics data store. The component then loops to block 602 to select the next identified field. In block 606, the component updates any aggregations in the analytics data store that are affected by the updates to the transactional data store. The component then completes.

The following paragraphs describe various embodiments of aspects of the analytics system. An implementation of the analytics system may employ any combination of the embodiments. The processing described below may be performed by a computing device with a processor that executes computer-executable instructions stored on a computer-readable storage medium that implements the analytics system.

In some embodiments, a method for providing an interface for supporting analytics processing of data of a transactional data store is provided. The method receives an analytics data model and a mapping of a transactional data model of the transactional data store to the analytics data model. The method initializes an analytics data store that supports the analytics data model by extracting data from the transactional data store and storing the extracted data in the analytics data store as indicated by the mapping, the analytics data store being separate from the transactional data store. The method registers to receive notifications of changes to data of the transactional data store. Upon receiving a notification of a change to data of the transactional data store, the method updates the data of the analytics data store as indicated by the mapping. The method receives via an analytics interface an analytics query based on the analytics data model, the analytics query being in an analytics query language. The method converts the analytics query into an analytics store query in analytics store query language. The analytics store query language is supported by an analytics store query engine for the analytics data store. The method submits the analytics store query to the analytics store query engine to generate a query result and provides the query result as the result of the analytics query. In some embodiments, the analytics data model is expressed as a star schema with fact tables and dimension tables representing the data of the analytics data store. In some embodiments, the initializing of the analytics data store includes, for each fact table and dimension table of the analytics data model, extracting data from a transactional table or view of the transactional data store as specified by the mapping and storing the extracted data in the analytics data store as a materialized table. In some embodiments, the updating of the data of the analytics data store includes, for a transactional view that has changed as a result of a change to a table, and for each table that supports the transactional view, generating a view based on the changes to that table and then combining the generated views to form a combined view of the changes. In some embodiments, the analytics data store is an in-memory data store that is stored in a columnar format. In some embodiments, the extracting of the data from the transactional data store extracts the data from a replica of the transactional data store. In some embodiments, the analytics interface applies a security model of the transactional data store to the analytics data store. In some embodiments, the analytics data store stores data extracted from multiple transactional data stores and the mapping maps transactional data models of the multiple transactional data stores to the analytics data model.

In some embodiments, a computing system for supporting analytics processing of data of a data source system is provided. The computing system comprises an analytics data model repository storing an analytics data model and a mapping from the analytics data model to a data source data model for a data source store. The computing system also comprises a computer-readable storage medium storing computer-executable instructions. The instructions include instructions of an extraction service that extracts data from the data source store for populating an analytics data store based on the mapping, initializes the analytics data store by storing the extracted data in the analytics data store, and updates the analytics data store based on changes to the data source store, the analytics data store being optimized for analytics processing. The instructions also include instructions of an analytics interface that provides the analytics data model for the data of the analytics data store, receives analytics queries in different analytics query languages based on the analytics data model for accessing data of the analytics data store, converts the analytics queries into analytics store queries in an analytics store query language and submits each analytics store query to an analytics store query engine that supports querying of the analytics data store, receives a query result from the analytics store query engine for each analytics store query, and provides the query result as the query result of the analytics query. The computing system comprises a processor that executes the computer-executable instructions stored in the computer-readable storage medium. In some embodiments, the analytics data model is expressed as a star schema with fact tables and dimension tables representing the data of the analytics data store. In some embodiments, the extraction service initializes the analytics data store by, for each fact table and dimension table of the analytics data model, extracting data from a table or view of the data source store as specified by the mapping and storing the extracted data in the analytics data store as a materialized table. In some embodiments, the extraction service updates the data of the analytics data store by, for a view that has changed as a result of a change to a table, and for each table that supports the view, generating a view based on the changes to that table and then combining the generated views to form a combined view of the changes. In some embodiments, the analytics data store is an in-memory data store that is stored in a columnar format. In some embodiments, the analytics interface applies a security model of the data source store to the analytics data store. In some embodiments, the computer-readable storage medium further stores computer-executable instructions that generate the mapping and receive from a user an indication of fields of the data source data model that map to fields of the analytics data model. In some embodiments, the instructions that generate the mapping further receive from the user an indication of a conversion to perform on data of a field of the data source data model.

In some embodiments, a computer-readable storage medium storing computer-executable instructions that, when executed, support analytics processing of data of a data source store, is provide. The computer-executable instructions comprise instructions that receive an analytics data model and a mapping of a data source data model of the data source store to the analytics data model. The computer-executable instructions comprise instructions that initialize an analytics data store that supports the analytics data model by extracting data from the data source store and storing the extracted data in the analytics data store as indicated by the mapping, the analytics data store being separate from the data source store. The computer-executable instructions comprise instructions that, upon receiving a notification of a change to data of the data source store, update the data of the analytics data store as indicated by the mapping. The computer-executable instructions comprise instructions that receive analytics queries in different analytics query languages based on the analytics data model and, for each analytics query, convert the analytics query into an analytics store query in an analytics store query language, submit the analytics store query to an analytics store query engine to generate a query result, and provide the query result as a result of the analytics query. In some embodiments, the analytics queries in the different analytics query languages are received from different application programs. In some embodiments, the computer-executable instructions further comprise instructions that generate the mapping and receive from a user an indication of fields of the data source data model that map to fields of the analytics data model. In some embodiments, the instructions that generate the mapping further receive from the user an indication of a conversion to perform on data of a field of the data source data model.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method for providing an interface for supporting analytics processing of data of a transactional data store, the method comprising:
receiving an analytics data model and a mapping of a transactional data model of the transactional data store to the analytics data model;
initializing an analytics data store that supports the analytics data model by extracting data from the transactional data store and storing the extracted data in the analytics data store as indicated by the mapping, the analytics data store being separate from the transactional data store;
registering to receive notifications of changes to data of the transactional data store;
upon receiving a notification of a change to data of the transactional data store, updating the data of the analytics data store as indicated by the mapping;
receiving via an analytics interface an analytics query based on the analytics data model, the analytics query being in an analytics query language;
converting the analytics query into an analytics store query in analytics store query language, the analytics store query language supported by an analytics store query engine for the analytics data store;
submitting the analytics store query to the analytics store query engine to generate a query result; and
providing the query result as the result of the analytics query.

2. The method of claim 1 wherein the analytics data model is expressed as a star schema with fact tables and dimension tables representing the data of the analytics data store.

3. The method of claim 2 wherein the initializing of the analytics data store includes, for each fact table and dimension table of the analytics data model, extracting data from a transactional table or view of the transactional data store as specified by the mapping and storing the extracted data in the analytics data store as a materialized table.

4. The method of claim 2 wherein the updating of the data of the analytics data store includes, for a transactional view that has changed as a result of a change to a table, and for each table that supports the transactional view, generating a view based on the changes to that table and then combining the generated views to form a combined view of the changes.

5. The method of claim 1 wherein the analytics data store is an in-memory data store that is stored in a columnar format.

6. The method of claim 1 wherein the extracting of the data from the transactional data store extracts the data from a replica of the transactional data store.

7. The method of claim 1 wherein the analytics interface applies a security model of the transactional data store to the analytics data store.

8. The method of claim 1 wherein the analytics data store stores data extracted from multiple transactional data stores and the mapping maps transactional data models of the multiple transactional data stores to the analytics data model.

9. A computing system for supporting analytics processing of data of a data source system, the computing system comprising:
an analytics data model repository storing an analytics data model and a mapping from the analytics data model to a data source data model for a data source store;
a computer-readable storage medium storing computer-executable instructions of:
an extraction service that extracts data from the data source store for populating an analytics data store based on the mapping, initializes the analytics data store by storing the extracted data in the analytics data store, and updates the analytics data store based on changes to the data source store, the analytics data store being optimized for analytics processing; and
an analytics interface that provides the analytics data model for the data of the analytics data store, receives analytics queries in different analytics query languages based on the analytics data model for accessing data of the analytics data store, converts the analytics queries into analytics store queries in an analytics store query language and submits each analytics store query to an analytics store query engine that supports querying of the analytics data store, receives a query result from the analytics store query engine for each analytics store query, and provides the query result as the query result of the analytics query; and
a processor that executes the computer-executable instructions stored in the computer-readable storage medium.

10. The computing system of claim 9 wherein the analytics data model is expressed as a star schema with fact tables and dimension tables representing the data of the analytics data store.

11. The computing system of claim 10 wherein the extraction service initializes the analytics data store by, for each fact table and dimension table of the analytics data model, extracting data from a table or view of the data source store as specified by the mapping and storing the extracted data in the analytics data store as a materialized table.

12. The computing system of claim 10 wherein the extraction service updates the data of the analytics data store by, for a view that has changed as a result of a change to a table, and for each table that supports the view, generating a view based on the changes to that table and then combining the generated views to form a combined view of the changes.

13. The computing system of claim 9 wherein the analytics data store is an in-memory data store that is stored in a columnar format.

14. The computing system of claim 9 wherein the analytics interface applies a security model of the data source store to the analytics data store.

15. The computing system of claim 9 wherein the computer-readable storage medium further stores computer-executable instructions that generate the mapping and receive from a user an indication of fields of the data source data model that map to fields of the analytics data model.

16. The computing system of claim 15 wherein the instructions that generate the mapping further receive from the user an indication of a conversion to perform on data of a field of the data source data model.

17. A computer-readable storage medium storing computer-executable instructions that, when executed, support analytics processing of data of a data source store, the computer-executable instructions comprising:
instructions that receive an analytics data model and a mapping of a data source data model of the data source store to the analytics data model;
instructions that initialize an analytics data store that supports the analytics data model by extracting data from the data source store and storing the extracted data in the analytics data store as indicated by the mapping, the analytics data store being separate from the data source store;
instructions that, upon receiving a notification of a change to data of the data source store, update the data of the analytics data store as indicated by the mapping; and
instructions that receive analytics queries in different analytics query languages based on the analytics data model and, for each analytics query, convert the analytics query into an analytics store query in an analytics store query language, submit the analytics store query to an analytics store query engine to generate a query result, and provide the query result as a result of the analytics query.

18. The computer-readable storage medium of claim 17 wherein the analytics queries in the different analytics query languages are received from different application programs.

19. The computer-readable storage medium of claim 17 wherein the computer-executable instructions further comprise instructions that generate the mapping and receive from a user an indication of fields of the data source data model that map to fields of the analytics data model.

20. The computer-readable storage medium of claim 19 wherein the instructions that generate the mapping further receive from the user an indication of a conversion to perform on data of a field of the data source data model.
